(19) United States
(12) Patent Application Publication
(10) Pub. No.: US 2020/0125926 A1
(43) Pub. Date: Apr. 23, 2020

(54) Dynamic Batch Sizing for Inferencing of Deep Neural Networks in Resource-Constrained Environments

(71) Applicant: International Business Machines Corporation, Armonk, NY (US)

(72) Inventors: Anamitra Roy Choudhury, New Delhi (IN); Saurabh Goyal, New Delhi (IN); Yogish Sabharwal, New Delhi (IN); Ashish Verma, New Delhi (IN); Dharma Teja Vooturi, New Delhi (IN)

(21) Appl. No.: 16/167,727

(22) Filed: Oct. 23, 2018

(51) Int. Cl. G06N 3/04; G06N 3/08

(52) U.S. Cl. CPC G06N 3/0454; G06N 3/082

(57) ABSTRACT

Methods, systems, and computer program products for dynamic batch sizing for inferencing of deep neural networks in resource-constrained environments are provided herein. A computer-implemented method includes obtaining, as input for inferencing of one or more deep neural networks, (i) an inferencing model and (ii) one or more resource constraints; computing, based at least in part on the obtained input, a set of statistics pertaining to resource utilization for each of multiple layers in the one or more deep neural networks; determining, based at least in part on (i) the obtained input and (ii) the computed set of statistics, multiple batch sizes to be used for inferencing the multiple layers of the one or more deep neural networks; and outputting, to at least one user, the determined batch sizes to be used for inferencing the multiple layers of the one or more deep neural networks.

### FIELD

The present application generally relates to information technology and, more particularly, to deep neural network technologies.

### BACKGROUND

Deep neural networks are used for a variety of artificial intelligence applications such as computer vision, speech recognition, natural language processing, etc. Additionally, such deep learning models can be used on mobile phones and other edge devices in the context of Internet of Things (IoT). Thus, inferencing can be carried out either on the cloud or the edge device itself. Inferencing, as used herein, refers to the stage wherein a trained network predicts and/or classifies input test samples. However, as datasets increase in size, so do the number of layers in the deep neural networks as well as the number of parameters used to absorb the large amount of supervision. Such large models can be difficult to use, for example, in low-resource environments. Even when inferencing is carried out on the cloud, resources often need to be efficiently utilized to limit the cost of inferencing. Moreover, multiple customized deep learning models (for various domains and users) may need to be kept in memory in order to provide sufficient response time for inferencing.

### SUMMARY

In one embodiment of the present invention, techniques for dynamic batch sizing for inferencing of deep neural networks in resource-constrained environments are provided. An exemplary computer-implemented method can include obtaining, as input for inferencing of one or more deep neural networks, (i) an inferencing model and (ii) one or more resource constraints; computing, based at least in part on the obtained input, a set of statistics pertaining to resource utilization for each of multiple layers in the one or more deep neural networks; determining, based at least in part on (i) the obtained input and (ii) the computed set of statistics, multiple batch sizes to be used for inferencing the multiple layers of the one or more deep neural networks; and outputting, to at least one user, the determined batch sizes to be used for inferencing the multiple layers of the one or more deep neural networks.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating batch size optimization, according to an embodiment of the invention;

FIG. 2 is a diagram illustrating a model with branches, according to an exemplary embodiment of the invention;

FIG. 3 is a diagram illustrating an algorithm for computing individual layer batch sizes, according to an exemplary embodiment of the invention;

FIG. 4 is a diagram illustrating system architecture, according to an exemplary embodiment of the invention;

FIG. 5 is flow diagram illustrating techniques according to an embodiment of the invention;

FIG. 6 is a system diagram of an exemplary computer system on which at least one embodiment of the invention can be implemented;

FIG. 7 depicts a cloud computing environment according to an embodiment of the present invention; and

FIG. 8 depicts abstraction model layers according to an embodiment of the present invention.

### DETAILED DESCRIPTION

As described herein, an embodiment of the present invention includes dynamic batch sizing for inferencing of deep neural networks in resource-constrained environments. At least one embodiment includes enabling variable batch inferencing in feed forward networks for resource-constrained environments by determining optimal individual layer batch sizes to be used for inferencing at different layers. A feed forward network, as used herein, refers to a network wherein the connections between the layers do not form a cycle. Such an embodiment includes determining individual layer batch sizes for inferencing using one or more models used for inferencing and resource constraints (such as total available memory, maximum latency for inferencing, maximum energy for inferencing, etc.) as input. Additionally, such an embodiment includes computing a set of statistics related to resource utilization (such as activation memory size, working memory, inference time, etc.) for each of the layers in the given feed forward network, and determining one or more optimal batch size sequences to be used by the different layers of the model for inferencing, wherein the one or more batch size sequences increase throughput and/or reduce energy or power consumption.

As detailed in the article by Vooturi et al., entitled “Efficient Inferencing of Compressed Deep Neural Networks” and published on Nov. 1, 2017, which is incorporated by reference herein in its entirety, at least one embodiment of the invention includes generating and/or implementing a dynamic program that can handle arbitrary sequences of batch sizes, as well as employing dynamic and variable batch sizes across layers (depending on the system load) of a network.

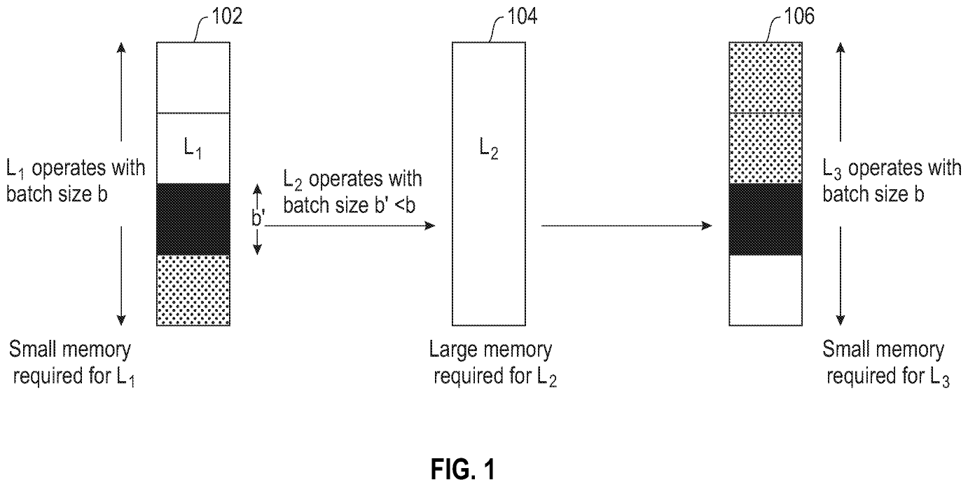

FIG. 1 is a diagram illustrating batch size optimization, according to an embodiment of the invention. By way of illustration, FIG. 1 depicts a first deep neural networks layer (L₁) 102, a second layer (L₂) 104, and a third layer (L₃) 106. As detailed herein, given memory availability, one or more embodiments of the invention include computing different batch sizes for different layers. By way merely of example, with uniform batch size, a memory requirement of layer L₂ 104 can restrict the batch size that can be processed for the network. Additionally, a larger batch size of b can be used for layers L₁ 102 and L₃ 106, while a b′<b batch size can be used for layer L₂ 104.

Accordingly, such an example embodiment (and as depicted in FIG. 1) can include processing layer L₁ 102 with a batch size of b, producing output activations of b samples at layer L₁ 102. This can be followed by b/b′ phases, wherein in each phase, layer L₂ 104 is processed with a batch size of b′. Activations of b samples are available as input for layer L₃ 106, and one or more embodiments of the invention can include processing layer L₃ 106 with a batch size of b.

By way of further explanation and/or illustration, such an embodiment can include utilization of a batch size optimizer. In such an embodiment, L₁, L₂, . . . , Lₙ represent the n layers of the network. A simple path network, for example, can include an output of layer Lᵢ being fed only into its successor layer Lᵢ₊₁. As also used in conjunction with one or more such embodiments, time (i, b) refers to the time per sample to process layer Lᵢ with a batch size of b. Additionally, in(i, b) refers to the memory required to store activations for b input samples for layer Lᵢ, out(i, b) refers to the memory required to store activations for b output samples for layer Lᵢ, ws(i, b) refers to the temporary workspace required for processing layer Lᵢ with batch size of b, and Tot refers to the total memory available in the system.

Further, in at least one embodiment of the invention, a configuration <i, b, mem> is feasible if the total memory required for performing inferencing computations at layer Lᵢ with a batch size of b, is at most mem (that is, in(i, b)+ws(i, b)+out(i, b)≤mem).

Also, one or more embodiments of the invention include maintaining at least two dynamic program tables, which can include OPT[⋅,⋅,⋅,⋅] and OPT Exact[⋅,⋅,⋅,⋅]. OPT[i, j, b, mem] refers to an optimal per-sample time to perform inferencing computations from layer Lᵢ to Lⱼ, wherein the layers Lᵢ, Lᵢ₊₁, . . . , Lⱼ use a total of at most mem units of memory, and each of the layers Lᵢ, Lᵢ₊₁, . . . , Lⱼ is computed using a batch size at most b. Additionally, OPT Exact[i, j, b, mem] refers to an optimal per-sample time to perform inferencing computations from layer Lᵢ to Lⱼ, wherein the layers Lᵢ, Lᵢ₊₁, . . . , Lⱼ use a total of at most mem units of memory, and one of the layers Lᵢ, Lᵢ₊₁, . . . , Lⱼ is computed using a batch size of exactly b, while the rest of the layers are computed with a batch size of at most b.

Accordingly, at least one embodiment of the invention includes implementing the following equations:

$$OPTExact [ i , j , b , mem ] = {min}_{i \leq k \leq j} \{ \begin{matrix}OPT [ 1 , k - 1 , b , mem ] \\ + OPTExact [ k , k , b , mem ] , \\ + OPT [ k + 1 , j , b , mem ]\end{matrix} \qquad ( 1 )$$

wherein OPT[i, j, b, mem]=0 for i>j, and wherein maxio(i, j, b−b′)=max{in(i, b−b′),out(j, b−b′)};

(2) OPT[i, j, b, mem]=min_{b′|b}{OPTExact(i, j, b′, mem−maxio(i, j, b−b′)]}; and

$$OPTExact [ i , i , b , mem ] = \{ \begin{matrix}time ( i , b ) , & if 〈 i , b , m 〉 is feasible \\ α , & else\end{matrix} , \qquad ( 3 )$$

wherein optimal throughput corresponds to OPT[1, n, b, TOT].

Equation (1) can be derived as follows. Suppose in the optimal solution for OPTExact[i, j, b, mem], layer Lₖ (i≤k≤j) is computed with batch size b. As such, the total time per sample to compute layers Lᵢ to Lⱼ in this scenario can be expressed as the sum of three quantities: (i) the optimal time per sample to compute layers Lᵢ to Lₖ₋₁ using batch size at most b with memory mem, (ii) the optimal time per sample to compute layer Lₖ with batch size b and memory mem (this is finite only if <k, b, mem> is feasible), and (iii) the optimal time per sample to compute layers Lₖ₊₁ to Lⱼ using batch size at most b and memory mem. As the layer Lₖ can be unknown, every layer between Lᵢ and Lⱼ can be considered, and the layer Lₖ that provides the best solution can be selected.

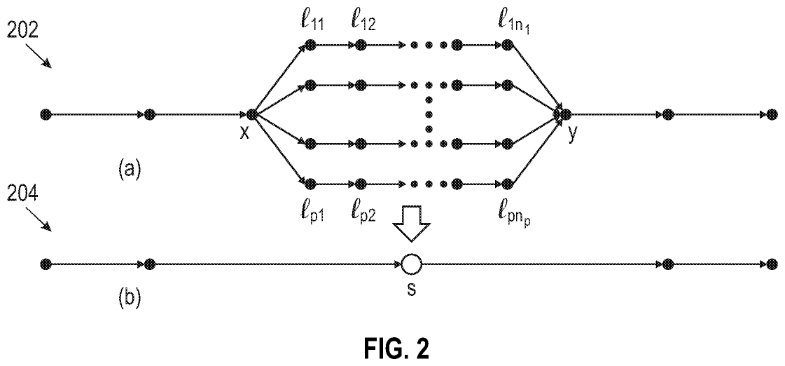

FIG. 2 is a diagram illustrating a model with branches, according to an exemplary embodiment of the invention. By way of illustration, FIG. 2 depicts an example embodiment of the invention that includes utilizing one or more models with branches. In such networks, there is a main path (as described herein), but between two nodes of this main path, there can be multiple branches. This class of networks can encompass more complex networks. For example, FIG. 2 depicts branch 202. Between two layers Lₓ and L_{y}, there may be multiple, say p, branches of layers < [symbol] ₁₁, [symbol] ₁₂, . . . , [symbol] ₁ₙ_{₁}>, < [symbol] ₂₁, [symbol] ₂₂, . . . , [symbol] ₂ₙ_{₂}>, . . . , < [symbol] ₚ₁, [symbol] ₚ₂, . . . , [symbol] ₚₙ_{₂}>. This case can be handled by collapsing all of the branch layers appearing between the two layers of the main path into a single special layer, as shown in element 204 in FIG. 2. This modification reduces the network to a simple path network. The optimal solution can therefore be obtained from Equations (1), (2) and (3) detailed above, provided OPTExact[s,s,⋅,⋅] can be computed for each special layer Lₛ.

Additionally, such an embodiment of the invention can include implementing the following equation: OPTExact(s, s, b, mem)=Σ_{∝=1}^{p}min_{b′|b}{OPTExact_{∝}(1, n_{∝}, b′, mem′)}, wherein mem′=mem−in(x, b)−out(y, b). The above equation can be derived as follows. Because each branch is a simple path of layers, equations (1), (2), and (3) can be applied to each branch. The notation OPTExact_{∝} can be used to refer to the optimal solution of the branch a. Suppose, for example, that the special layer Lₛ is being computed with a batch size of b. The computation for any branch a can be carried out with some batch size b′≤b, and therefore the branch a can process the b samples in multiple phases. Moreover, it can be assumed that the branches are processed sequentially; that is, branch (a+1) will compute only after branch a finishes the computation for all the b samples. Therefore, the memory available for each of the branches to carry out the computation is mem′, because the input and output activations of b samples need to be reserved at layers Lₓ and L_{y}, respectively.

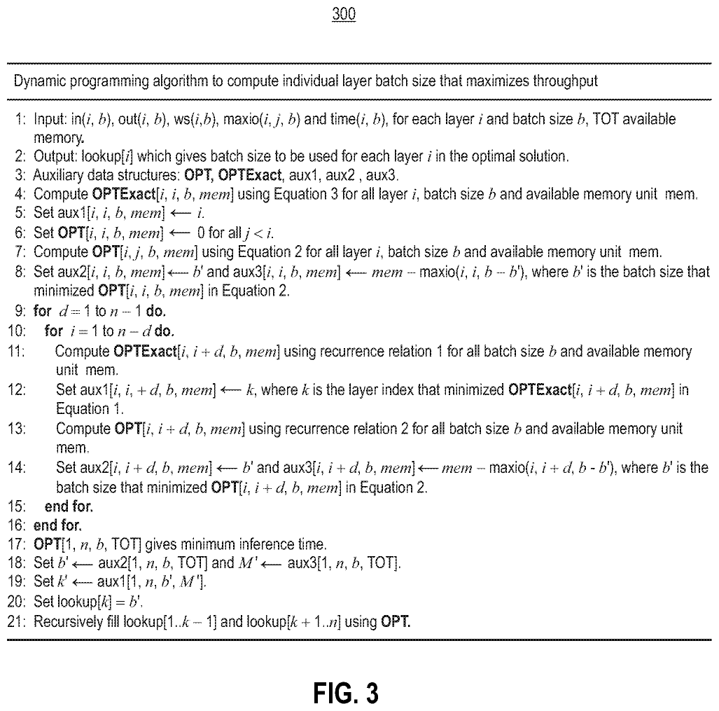

FIG. 3 is a diagram illustrating an algorithm 300 for computing individual layer batch sizes, according to an exemplary embodiment of the invention. Equation (3), detailed above, can be employed to first handle the base case wherein the starting layer and the ending layer represent the same layer. Entries can then be computed, wherein the starting and ending layers differ by 1, then by 2, and so on. Thus, for d=1 to n−1, the entries OPTExact[i, j, b, mem] can be computed using Equation (1) and then OPT[i, j, b, mem] can be computed using Equation (2), wherein j=i+d, 1≤i≤j≤n. The required optimal solution for inferencing b samples with available memory mem can ultimately be obtained from the entry OPT[1, n, b, TOT]. The optimal choice at each step can be tracked using auxiliary data structures aux1, aux2, aux3 in order to determine the batch sizes employed by different layers corresponding to the optimal solution.

Such an embodiment as described above can be extended to ensure that the latency of inferencing does not exceed some given requirement. This can be achieved by modifying Equation (1) so that whenever OPTExact[⋅,⋅,⋅,⋅] exceeds the required latency threshold, the value is set to infinity. Similarly, such an embodiment can also be extended to cater to optimizing battery/energy consumption. This can be done by filling the table entries in the base case with battery/energy consumption values instead of time values.

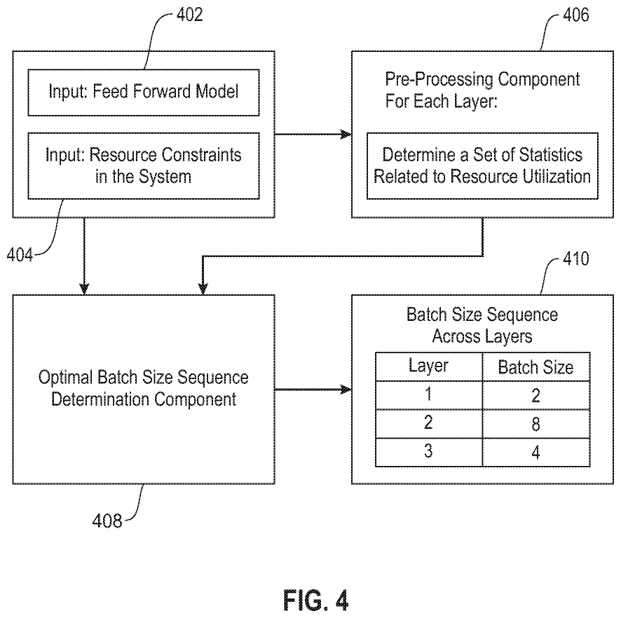

FIG. 4 is a diagram illustrating system architecture, according to an exemplary embodiment of the invention. By way of illustration, FIG. 4 depicts input 402 and input 404, wherein input 402 includes a feed forward model and input 404 includes resource constraints for the given system (such as, for example, available memory, permissible latency, etc.). Inputs 402 and 404 are provided to pre-processing component 406 and optimal batch size sequence determination component 408. As depicted in FIG. 4, the pre-processing component 406 determines, for each layer of the feed forward network 402, a set of statistics related to resource utilization. Such statistics can include, for example, working memory, input and output activation size for every batch size, time and/or energy to compute the layer for every batch size, etc. The input/output activation sizes for each batch size, the working memory for each batch size maxio(⋅,⋅,⋅), etc. can be statically computed. Determining time/energy to compute a layer for a batch size requires a run through each layer with the corresponding batch sizes. All of these entries can be computed once for a given model.

Additionally, as also depicted in FIG. 4, the optimal batch size sequence determination component 408, using inputs 402 and 404, as well as the statistics determined by the pre-processing component 406, determines one or more optimal batch size sequences for the layers of the feed forward network, as shown in algorithm 300. In making such determinations, component 408 attempts to maximize throughput, minimize energy consumption, maintain one or more latency parameters, and/or maintain one or more memory requirements, as detailed above. Further, component 408 outputs a batch size sequence 410 across multiple layers of the feed forward network.

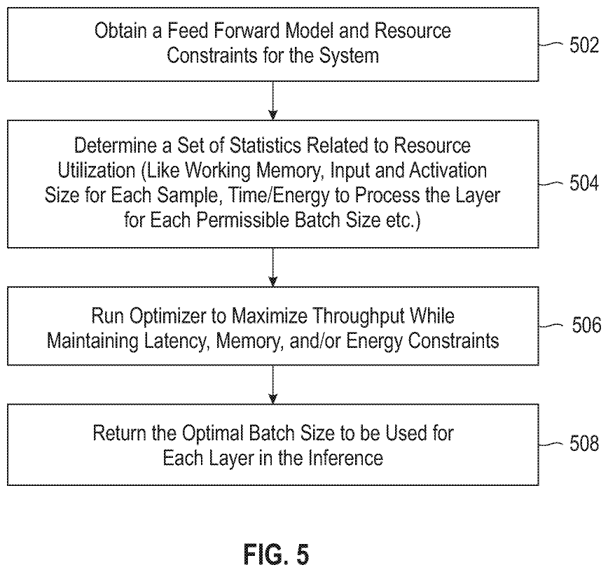

FIG. 5 is flow diagram illustrating techniques according to an embodiment of the invention. Step 502 includes obtaining a feed forward model and resource constraints for the system. Step 504 includes determining a set of statistics related to resource utilization (such as working memory, input and activation size for each sample, time/energy to process the layer for each permissible batch size, etc.). Step 506 includes running an optimizer to maximize throughput while maintaining latency, memory, and/or energy constraints. Step 508 includes outputting/returning an optimal batch size to be used for each layer in the inference.

Accordingly, at least one embodiment of the invention can include obtaining, as input for inferencing of one or more deep neural networks, (i) an inferencing model and (ii) one or more resource constraints; computing, based at least in part on the obtained input, a set of statistics pertaining to resource utilization for each of multiple layers in the one or more deep neural networks; determining, based at least in part on (i) the obtained input and (ii) the computed set of statistics, multiple batch sizes to be used for inferencing the multiple layers of the one or more deep neural networks; and outputting, to at least one user, the determined batch sizes to be used for inferencing the multiple layers of the one or more deep neural networks.

In such an embodiment, the inferencing model can include a feed forward model. Additionally, the inferencing model can include a compressed model generated through weight-based pruning, a compressed model generated through at least one of (i) quantization and (ii) weight sharing, a compressed model generated through relative indexing, and/or a compressed model generated through encoding.

Further, in such an embodiment, the one or more resource constraints can include at least one of (i) total available memory, (ii) maximum latency for inferencing, and (iii) maximum energy for inferencing. Also, the set of statistics can include at least one of (i) amount of working memory, (ii) input and activation size for each sample, (iii) time to process a layer for each of multiple permissible batch sizes, and (iv) energy to process a layer for each of multiple permissible batch sizes.

Additionally, in such an embodiment, the batch size determination step can include determining a sequence of variable batch sizes corresponding to the multiple layers of the one or more deep neural networks. Such a determination step can also increase one or more throughput values associated with the inferencing of the one or more deep neural networks, decrease one or more energy values associated with the inferencing of the one or more deep neural networks, decrease one or more latency values associated with the inferencing of the one or more deep neural networks, and/or decrease one or more memory values associated with the inferencing of the one or more deep neural networks.

Further, the techniques depicted in FIG. 5 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 5 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

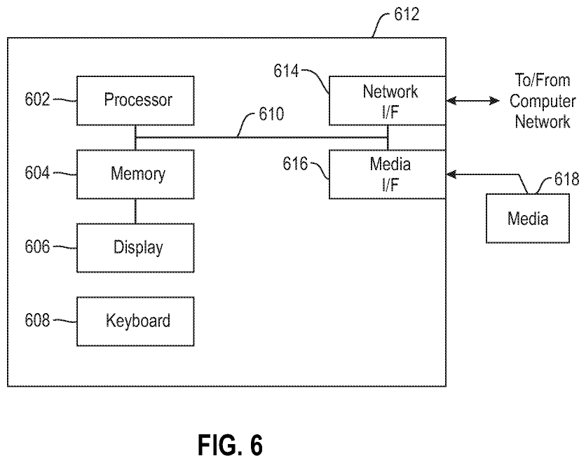

Additionally, an embodiment of the present invention can make use of software running on a computer or workstation. With reference to FIG. 6, such an implementation might employ, for example, a processor 602, a memory 604, and an input/output interface formed, for example, by a display 606 and a keyboard 608. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 602, memory 604, and input/output interface such as display 606 and keyboard 608 can be interconnected, for example, via bus 610 as part of a data processing unit 612. Suitable interconnections, for example via bus 610, can also be provided to a network interface 614, such as a network card, which can be provided to interface with a computer network, and to a media interface 616, such as a diskette or CD-ROM drive, which can be provided to interface with media 618.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 602 coupled directly or indirectly to memory elements 604 through a system bus 610. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 608, displays 606, pointing devices, and the like) can be coupled to the system either directly (such as via bus 610) or through intervening I/O controllers (omitted for clarity).

Network adapters such as network interface 614 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 612 as shown in FIG. 6) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out embodiments of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present invention.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 602. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that implementation of the teachings recited herein are not limited to a particular computing environment. Rather, embodiments of the present invention are capable of being implemented in conjunction with any type of computing environment now known or later developed.

For example, cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

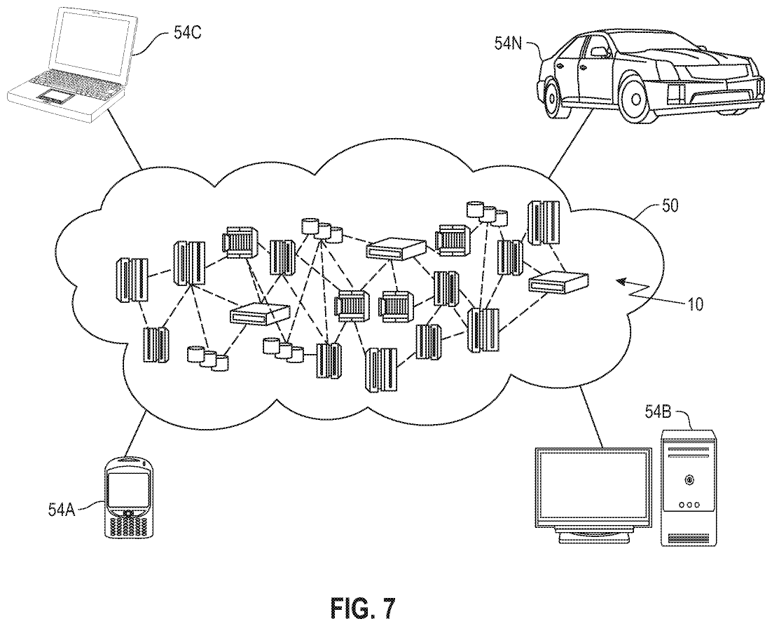

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

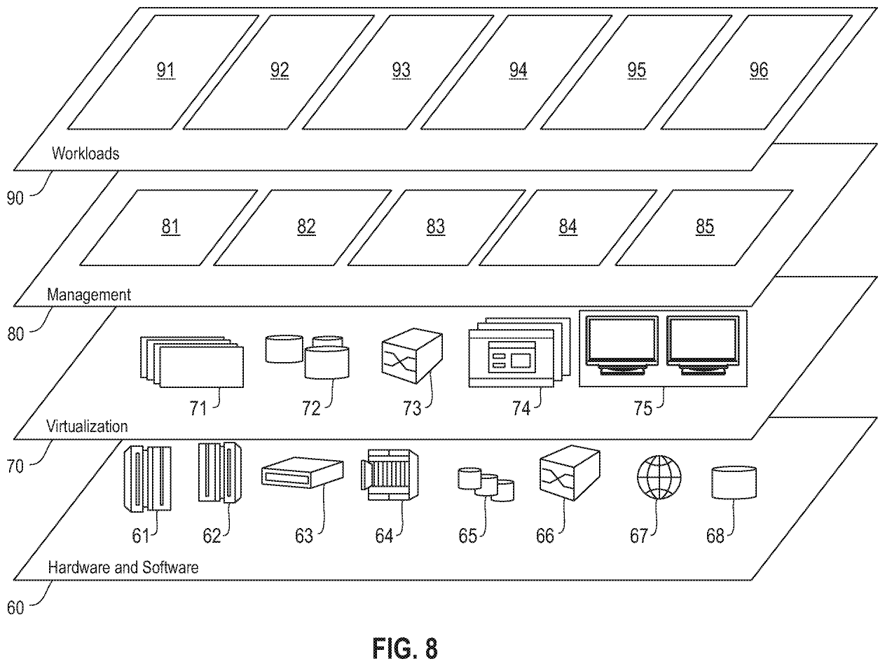

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and batch sizing determination 96, in accordance with the one or more embodiments of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, enabling variable batch inferencing in feed forward networks for resource-constrained environments by determining optimal individual layer batch sizes to be used for inferencing at different layers.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, the method comprising steps of:
obtaining, as input for inferencing of one or more deep neural networks, (i) an inferencing model and (ii) one or more resource constraints;
computing, based at least in part on the obtained input, a set of statistics pertaining to resource utilization for each of multiple layers in the one or more deep neural networks;
determining, based at least in part on (i) the obtained input and (ii) the computed set of statistics, multiple batch sizes to be used for inferencing the multiple layers of the one or more deep neural networks; and
outputting, to at least one user, the determined batch sizes to be used for inferencing the multiple layers of the one or more deep neural networks;
wherein the steps are carried out by at least one computing device.

2. The computer-implemented method of claim 1, wherein the inferencing model comprises a feed forward model.

3. The computer-implemented method of claim 1, wherein the inferencing model comprises a compressed model generated through weight-based pruning.

4. The computer-implemented method of claim 1, wherein the inferencing model comprises a compressed model generated through at least one of (i) quantization and (ii) weight sharing.

5. The computer-implemented method of claim 1, wherein the inferencing model comprises a compressed model generated through relative indexing.

6. The computer-implemented method of claim 1, wherein the inferencing model comprises a compressed model generated through encoding.

7. The computer-implemented method of claim 1, wherein the one or more resource constraints comprises at least one of (i) total available memory, (ii) maximum latency for inferencing, and (iii) maximum energy for inferencing.

8. The computer-implemented method of claim 1, wherein the set of statistics comprises at least one of (i) amount of working memory, (ii) input and activation size for each sample, (iii) time to process a layer for each of multiple permissible batch sizes, and (iv) energy to process a layer for each of multiple permissible batch sizes.

9. The computer-implemented method of claim 1, wherein said determining comprises determining a sequence of variable batch sizes corresponding to the multiple layers of the one or more deep neural networks.

10. The computer-implemented method of claim 1, wherein said determining increases one or more throughput values associated with the inferencing of the one or more deep neural networks.

11. The computer-implemented method of claim 1, wherein said determining decreases one or more energy values associated with the inferencing of the one or more deep neural networks.

12. The computer-implemented method of claim 1, wherein said determining decreases one or more latency values associated with the inferencing of the one or more deep neural networks.

13. The computer-implemented method of claim 1, wherein said determining decreases one or more memory values associated with the inferencing of the one or more deep neural networks.

14. A computer program product comprising a computer readable storage medium having program instructions embodied therewith, the program instructions executable by a computing device to cause the computing device to:
obtain, as input for inferencing of one or more deep neural networks, (i) an inferencing model and (ii) one or more resource constraints;
compute, based at least in part on the obtained input, a set of statistics pertaining to resource utilization for each of multiple layers in the one or more deep neural networks;
determine, based at least in part on (i) the obtained input and (ii) the computed set of statistics, multiple batch sizes to be used for inferencing the multiple layers of the one or more deep neural networks; and
output, to at least one user, the determined batch sizes to be used for inferencing the multiple layers of the one or more deep neural networks.

15. The computer program product of claim 14, wherein the inferencing model comprises a feed forward model.

16. The computer program product of claim 14, wherein the one or more resource constraints comprises at least one of (i) total available memory, (ii) maximum latency for inferencing, and (iii) maximum energy for inferencing.

17. The computer program product of claim 14, wherein the set of statistics comprises at least one of (i) amount of working memory, (ii) input and activation size for each sample, (iii) time to process a layer for each of multiple permissible batch sizes, and (iv) energy to process a layer for each of multiple permissible batch sizes.

18. The computer program product of claim 14, wherein said determining comprises determining a sequence of variable batch sizes corresponding to the multiple layers of the one or more deep neural networks.

19. A system comprising:
a memory; and
at least one processor operably coupled to the memory and configured for:
obtaining, as input for inferencing of one or more deep neural networks, (i) an inferencing model and (ii) one or more resource constraints;
computing, based at least in part on the obtained input, a set of statistics pertaining to resource utilization for each of multiple layers in the one or more deep neural networks;
determining, based at least in part on (i) the obtained input and (ii) the computed set of statistics, multiple batch sizes to be used for inferencing the multiple layers of the one or more deep neural networks; and
outputting, to at least one user, the determined batch sizes to be used for inferencing the multiple layers of the one or more deep neural networks.

20. A computer-implemented method, the method comprising steps of:
obtaining, as input for inferencing of one or more deep neural networks, (i) an inferencing model, wherein the inferencing model comprises a feed forward model, and (ii) constraints comprising (a) total available memory, (b) maximum latency for inferencing, and (c) maximum energy for inferencing;
computing, based at least in part on the obtained input, a set of statistics pertaining to resource utilization for each of multiple layers in the one or more deep neural networks, wherein the set of statistics comprises (i) amount of working memory, (ii) input and activation size, (iii) time to process a layer for each of multiple batch sizes, and (iv) energy to process a layer for each of the multiple batch sizes;
determining, based at least in part on (i) the obtained input and (ii) the computed set of statistics, the multiple batch sizes to be used for inferencing the multiple layers of the one or more deep neural networks; and
displaying, to at least one user, the determined batch sizes to be used for inferencing the multiple layers of the one or more deep neural networks;
wherein the steps are carried out by at least one computing device.
